(19) United States
(12) Patent Application Publication
(10) Pub. No.: US 2009/0236844 A1
(43) Pub. Date: Sep. 24, 2009

(54) TAMPER EVIDENT MATERIALS FOR SECURELY CARRYING INFORMATION

(75) Inventors: Joel Van Boom, Santa Ana, CA (US); Peter Dronzek, Enfield, CT (US); Leslie U. Fernandez, Putnam Valley, NY (US)

Correspondence Address: KNOBBE MARTENS OLSON & BEAR LLP, 2040 MAIN STREET, FOURTEENTH FLOOR, IRVINE, CA, 92614, US

(73) Assignee: Documotion Research, Inc., Santa Ana, CA (US)

(21) Appl. No.: 12/371,554

(22) Filed: Feb. 13, 2009

Related U.S. Application Data
(60) Provisional application No. 61/028,863, filed on Feb. 14, 2008.

(51) Int. Cl. B42D 15/00

(52) U.S. Cl. 283/67; 283/103; 283/96; 283/72

(57) ABSTRACT

Tamper evident forms are provided having a transparent layer bonded to a scrambling layer. One or more coating layers may be disposed on the surface of the transparent laminar. Printed indicia on the upper surface of the form is not readable unless the transparent lamina is physically separated from the scrambling layer or if the scrambling layer is optically altered or negated. The coating layers may reveal tamper evidence if a surreptitious attempt of obtaining the printed indicia is made by physical, mechanical, electronic and/or chemical means without removing the separating the transparent lamina and the scrambling layer.

### CROSS REFERENCE TO RELATED APPLICATIONS

This application claims the benefit and priority to U.S. Provisional Application No. 61/028,863 filed on Feb. 14, 2008 and incorporated by reference in its entirety herein.

### BACKGROUND OF THE INVENTION

1. Field of the Invention

The invention relates to tamper evident materials, such as forms, for securely carrying information.

2. Description of the Related Technology

Information is frequently sent through the mail or other channels, such as courier or document delivery, that is to remain confidential or concealed until it reaches its intended recipient. For example, banks often send by mail materials bearing personal identification numbers (PINs) that are associated with their customer's accounts, credit or debit cards. Such information is usually concealed in printed materials that will show to the intended recipient if they have been tampered with by someone trying to gain access to the confidential information. It is also highly desirable that the confidential information is hidden from the moment of printing, though most tamper evident forms are constructed such that further processing of the form, such as coating or folding and sealing, is required to secure the information after the form has been printed with the confidential information.

U.S. Pat. Nos. 6,220,633 and 6,231,082, issued to Van Boom, describe tamper evident forms comprising a transparent printable layer overlaying a scrambling pattern. The scrambling pattern can be removed in various ways with respect to the transparent layer to reveal the print on the transparent layer. Typically, the print is printed by conventional printers and no post processing is required.

Tamper evident materials that carry the confidential information on the top layer are susceptible to various means by which unauthorized people may attempt to read the information by lifting it onto another substrate. These include the use of adhesive tape, heat or various chemicals, such as solvents. For example, a thief might use a piece of blotting tape and an iron in order to lift ink from the upper layer. As such, there is a need to make such forms more resistant to tampering and to make them tamper evident in response to such attacks in order to protect valuable information, such as PINs, from being surreptitiously detected without the knowledge of the intended recipient of the information.

### SUMMARY

Embodiments of the invention broadly relate to the ability of certain materials, such as printed paper materials such as forms, to convey confidential information to an intended recipient. In the event that such forms are tampered with by a person attempting to obtain illicitly the confidential information, the form should at least reveal some evidence of tampering. Methods of surreptitious detection of the confidential information exist to design around security features of such forms. In order to thwart attempts to lift confidential information from a form by physical or chemical methods, the forms of the present invention can prevent detection of the confidential information and/or reveal evidence of such tampering.

The tamper evident forms of the present invention generally provide confidential information on an upper transparent layer. The upper transparent layer may be positioned above a lower scrambling layer. The lower scrambling layer generally serves to prevent information printed on the upper transparent layer from being readable. U.S. Pat. Nos. 6,220,633, 6,231,082, and 6,481,753, which are herein incorporated by reference in their entireties, describe various embodiments of a transparent layer removably affixed to a scrambling means which hides printed information on the transparent layer from being read. Similarly, embodiments of the tamper evident forms described herein also include one or more transparent layers positioned above and bonded either directly or indirectly to a lower scrambling layer.

Preferably, embodiments of the tamper evident forms are configured to be passed through a conventional printer such as a laser or ink-jet printer. The upper transparent layer is adapted to receive printed indicia deposited by a conventional printer. However, such information cannot be viewed or detected while the underlying scrambling layer is positioned below the upper transparent layer. An intended recipient of the printed indicia may follow instructions on the form and separate the upper transparent layer and the scrambling layer, or to optically alter or negate the scrambling layer, thus revealing the confidential information on the upper transparent layer.

Embodiments of the tamper evident forms also contain one or more additional security features which would alert the intended recipient of the printed indicia to tampering. While certain security features only serve to alert the intended recipient, other security features of the tamper evident forms will prevent the surreptitious detection of the printed indicia. In certain embodiments, the tamper evident forms contain one or more security features which prevent the detection of the printed indicia by the destruction of the indicia upon tampering. In others embodiments, the tamper evident forms contain one or more security features which prevent the detection of the printed indicia by obscuring the view of the indicia upon tampering. Such security features are further described herein.

Certain types of security features may be incorporated into the tamper evident forms. One security feature described herein relates to a breakaway or release coating that releases in a manner that destroys the printed indicia if a person attempts to lift the upper transparent layer on which the indicia is printed. Another security feature described herein relates to a heat reactive composition which can, under certain conditions, bond to paper or film which is placed on top of the upper transparent layer in an attempt to transfer the ink or laser printed toner of the printed indicia. Another security feature relates to a composition which reacts and/or changes its appearance when exposed to a solvent commonly used in attempts to transfer ink from the printed indicia to another substrate, such as blotting paper. Another security feature relates to the inclusion of light-scattering particles, such as spheres or prisms, that defract light in the form in order to prevent the copying or scanning of the printed indicia on the upper transparent layer.

Any one of these security features may be featured in one or more coating layers above the scrambling means of the form. In certain embodiments, two or more coating layers may be used, each coating layer having single or multiple security functions. Such embodiments are further described below. It will be understood herein that reference to a layer need not indicate strata of significant depth or thickness, but is also intended to include coatings. Likewise, it also contemplated that layers may be deposited by coating techniques or by methods of extrusion, coextrusion, and the like. Such coatings are typically applied to a substrate layer having some integrity and then “cured”, such as by beating or drying.

One embodiment provides a tamper evident construction, such as a form, which comprises a breakaway layer partially covering an upper face of an upper, transparent layer, the upper face and the breakaway layer being adapted to receive printed information, and a lower layer comprising a scrambling pattern that renders such printed information unreadable. The construction may further comprise, in addition to the printed information, breakaway layer, transparent layer and scrambling pattern a lower substrate, such as paper or plastics film. The breakaway layer may be configured in a manner such that when a lifting force, such as an adhesive or the like, is applied to the printing and/or upper layer, the breakaway layer causes a separation in the construction to reveal the tampering.

Another embodiment provides a tamper evident construction, such as a form, which comprises a transparent layer reactive to chemicals at least partially covering, and preferably covering, an upper surface or face of an upper, transparent layer, the chemical reactive layer being adapted to receive printed information, and a lower layer comprising a scrambling pattern that renders such printed information unreadable. The construction may further comprise, in addition to the printed information, chemical reactive layer, transparent layer and scrambling pattern a lower substrate, such as paper or plastics film. The chemical reactive layer may react to chemicals, such as solvents, that are used in an attempt to access the information by changing the appearance of the construction, for example by changing the light transmission properties of the chemical reactive layer, such as by turning it milky or at least partially opaque.

Another embodiment provides a tamper evident construction, such as a form, Which comprises a transparent layer reactive to heat at least partially covering, and preferably covering, an upper face of an upper, transparent layer, the heat reactive layer being adapted to receive printed information, and a lower layer comprising a scrambling pattern that renders such printed information unreadable. The construction may further comprise, in addition to the printed information, heat reactive layer, transparent layer and scrambling pattern a lower substrate, such as paper or plastics film. The heat reactive layer may be adapted to be relatively insensitive to heat during the laser or inkjet printing and processing of the document bearing the construction, but relatively sensitive to heat applied to the construction in an attempt to access the information by fusing or otherwise reacting with the printed information to render it inaccessible and/or such that it is apparent that the construction has been tampered with.

Another embodiment provides such constructions comprising two of the breakaway, chemical reactive and heat reactive layers, or all three of them.

Thus one embodiment provides a tamper evident construction, such as a form, which comprises the breakaway layer partially covering the upper face of the upper, transparent layer and the heat reactive layer located on and above the breakaway layer, the heat reactive layer being adapted to receive the printed information.

Thus another embodiment provides a tamper evident construction, such as a form, which comprises the breakaway layer partially covering the upper face of the upper, transparent layer, the chemical reactive layer located on and above the breakaway layer and the heat reactive layer located on and above the chemical reactive layer, the heat reactive layer being adapted to receive the printed information.

In one embodiment, the breakaway layer may be adapted to partially or completely cover the upper face of the upper, transparent layer. In some embodiments, the breakaway layer covers the upper face of the upper, transparent layer in amount ranging from about 25 to about 75% of the surface area of the upper face. In some embodiments, the breakaway layer covers the upper face of the upper, transparent layer in amount ranging from about 40 to about 60% of the surface area of the upper face. The breakaway layer may further be configured to underlay at a least a portion of the printed indicia on the upper surface of the construction.

Portions of the upper transparent layer may be covered to provide various break away patterns to the break away coating. Patterns of the break away coating may include vertical stripes, horizontal stripes, diagonal stripes, circles, diamonds, or the like. The pattern of the break away coating may further be configured to underlay at a least a portion of the printed indicia on the upper surface of the construction. In certain embodiments, the pattern of the breakaway layer is designed such that release of the break away coating renders the printed indicia destroyed or unreadable. In one configuration, the pattern may render one or more characters of the printed indicia unreadable or unrecognizable by a person or machine. In one embodiment, the break away coating releases half of the printed indicia A half may include a left portion, a right portion, a top portion, a bottom portion, or one or more portions that are additive to approximately half of the surface of the upper face of the transparent layer.

Release of the break away coating may also be configured to interfere with the underlying scrambling means. In some embodiments, the release of the break away coating does not affect the underlying substrate which the scrambling means is affixed or adjacent to. In certain embodiments, the breakaway layer is designed to stay engaged to the upper transparent layer when the scrambling means is removed from the form. The scrambling means may be removed from a bottom surface of the upper transparent layer by being peeled away or scratched away, or may be optically altered or negated, depending on the type and configuration of the scrambling means.

The chemical reactive layer may be adapted to undergo a physical or chemical change when exposed to a substance in an attempt to remove or otherwise gain access to the printed indicia. Such unauthorized access to the printed indicia may typically be made from the upper surface of the construction; however, attack from the lower surface or the substrate may also be made. The physical or chemical change of the substrate may be a function of a chemical reaction or a result of physical differences between components which comprise the chemical reactive layer.

In one embodiment, the chemical reactive layer is adapted to change when exposed to a solvent. The chemical reactive layer may include a combination of materials having different solubility constants in one or more solvents. Such materials may be configured to be polymeric materials having different solubility constants in one or more solvents. While such materials may be homogeneously dispersed through mixing, exposure of the materials to one or more solvents may cause one material to dissolve, crystallize or precipitate from the mixture. Prior to exposure to the solvent, the chemical reactive layer may be configured to be transparent or partially transparent. Exposure to the solvent may result in a chemical layer that is more opaque than the layer prior to exposure.

The heat reactive layer may be configured to be on or near the upper surface of the construction. This configuration permits the heat reactive layer to be sensitive to attempts to remove printed indicia from the upper surface by heat. The heat reactive layer is configured to remain unaltered during normal printing conditions. As such, it may be run through laser printers with heating elements used to fix toner on the upper surface of the construction. However, the heat reactive layer is also configured to soften when exposed to heat under certain conditions conducive to at least the partial removal of toner from upper surface. The heat reactive layer preferably bonds to a transfer medium contacting the upper surface of the form under such heating conditions. This bonding provides evidence of tampering with a construction having a heat reactive layer. Such evidence may include marring or residue on the surface of the upper layer when the transfer medium is removed.

A combination of materials may be used in a heat reactive layer. In certain embodiments, a polymeric mixture and a particulate filler material are included in the heat reactive layer. The polymeric mixture may include a blend of at least two polymers, one polymer which would bind to the transfer medium on the upper surface if exposed to the heating conditions. A second polymer may act as a heat buffer layer which physically absorbs heat such that printed indicia may be received on the surface by a conventional printer such as a laser printer under designated conditions described herein. A particulate filler material may be dispersed throughout the heat reactive layer and may be dispersed on or adjacent to the upper face of the heat reactive layer. The particulate filler material may be configured to buffer heat exchange between the polymeric materials and a heating element of a printer.

In one embodiment, the particulate filler material may include platelet shaped particles. In certain embodiments, the particulate material includes acicular shaped particles. Certain embodiments include both. Such particle shapes may be adapted to provide a surface in which to receive toner from a printer while buffering heat from the polymeric components of the heat reactive layer.

Any one of the aforementioned embodiments are applied on top of the upper transparent layer. This film layer may be made of any material, including, but not limited to, polyester, cellophane, polypropylene, vinyl, polycarbonate and PLA (polymer of lactic acid) materials. In certain embodiments, this material is a transparent adhesive material. In some embodiments, this material comprises a material capable of receiving printed indicia. The upper transparent layer is configured to be in contact with one or more upper layers which are described above and adjacent to or in contact with the scrambling layer positioned below.

Any one of the forementioned embodiments may also include a scrambling layer. The scrambling layer is adapted to interfere with observation of printed indicia on the upper surface of the construction. In certain embodiments, the scrambling layer renders the indicia unreadable. In certain embodiments, the scrambling layer renders the indicia hidden. However, the scrambling layer is configured to be separated from the upper transparent layer, or may be optically altered or negated, to render the printed indicia observable or readable.

In one embodiment, a scrambling layer includes a saturated mass of overprint alpha-numeric characters. In another embodiment, the scrambling layer includes a darkly shaded or opaque area which prevents observation of the printed indicia. In another embodiment, the scrambling layer is a removable opaque coating deposited on the lower face of the transparent layer. In another embodiment, the scrambling layer is a removable opaque coating deposited on or adjacent to the substrate layer. In any of these embodiments, the scrambling layer portion may be configured to be scratched or peeled away. In another embodiment, the scrambling layer may be optically altered or negated so as to reveal the printed indicia. The scrambling means can comprise an ink or colorant that changes appearance. For example changing such as from apparent to clear by chemical or physical action can cause the scrambling means to disappear by becoming clear.

In any of the aforementioned embodiments, the construction preferably includes a substrate. In one embodiment, the substrate may be connected to the scrambling layer. In one embodiment, a portion of the substrate is adhered to the scrambling layer and is configured to be removed from the rest of the form with the scrambling layer in order to reveal the printed indicia on the upper surface of the form. In another embodiment, the upper transparent layer is adapted to be removed from the scrambling layer which is bonded to the substrate. In one embodiment, the upper transparent layer and the scrambling layer may be adhered beneath the substrate.

### BRIEF DESCRIPTION OF THE DRAWINGS

Some preferred embodiments of the invention will now be more particularly described by reference to the accompanying drawings, in which:

FIG. 1 is an exploded perspective schematic view of one embodiment of a tamper evident form having a scrambling layer, a transparent layer, a release layer, a solvent reactive layer, and a heat reactive layer.

FIG. 2 is a top view of a tamper evident form with scrambling layer attached.

FIG. 3A is a side view of a form having a transparent lamina and one or more upper coating layer separable from the face.

FIG. 3B represents the separation of the scrambling layer from the upper layers as shown in the form in FIG. 3A.

FIG. 4A is a side view of a form having a scrambling layer and substrate separable from the bottom of the form.

FIG. 4B represents the separation of the scrambling layer with a portion of the substrate from the upper layers as shown in the form in FIG. 4A.

FIG. 5A is a side view of a form having a scrambling layer separable from one or more upper layers without removing a substrate portion.

FIG. 5B illustrates separation of the scrambling layers from the one or more upper layers in the form shown in FIG. 5A.

FIG. 6A is a side view of a form having a scrambling layer with no substrate on its bottom surface.

FIG. 6B illustrates separation of the scrambling layer from the one or more upper layers in the form shown in FIG. 6A.

FIG. 7A is a side view which has an adhesive layer between the scrambling layer and the substrate, each of the scrambling layer, a portion of adhesive layer, and a portion of the substrate being separable from the bottom of the form.

FIG. 7B illustrates separation of the scrambling layer and various portions from the one or more upper layers in the form shown in FIG. 7A

FIG. 8A is a side view of another embodiment of a form.

FIG. 8B is illustrates separation of a scrambling layer from one or more upper layers in the form shown in FIG. 8A.

FIG. 9A is a side view of another embodiment of a form.

FIG. 9B illustrates separation of a scrambling layer from one or more upper layers in the form shown in FIG. 9A

FIG. 10 is a side view of a form having scrambling layer printed on the substrate, the scrambling layer being removable from the upper layers.

FIG. 11A is a top view of a tamper evident form with scrambling layer and substrate not attached.

FIG. 11B is a top view of a tamper evident form with scrambling layer and substrate attached.

FIG. 12 is an illustration of the result of a tamper evident form having its upper surface peeled away.

FIG. 13A is an exploded perspective view of one embodiment of a tamper evident form having a scrambling layer, a transparent layer, a release layer, and a heat reactive layer.

FIG. 13B is an exploded perspective view of one embodiment of a tamper evident form having a scrambling layer, a transparent layer, and a heat reactive layer.

FIG. 13C is an exploded perspective view of one embodiment of a tamper evident form having a scrambling layer, a transparent layer, and a solvent reactive layer.

FIG. 13D is an exploded perspective view of one embodiment of a tamper evident form having a scrambling layer, a transparent layer, a release layer, and a solvent reactive layer.

### DETAILED DESCRIPTION OF THE EMBODIMENTS

Embodiments will now be described with reference to the drawings provided. Although the features of the tamper evident forms will be discussed in connection with the drawings, it is understood that such discussion is to facilitate an understanding of the preferred embodiments only, and is not intended to limit the scope of the disclosure or claims to the tamper-evident forms and methods of making and using the same.

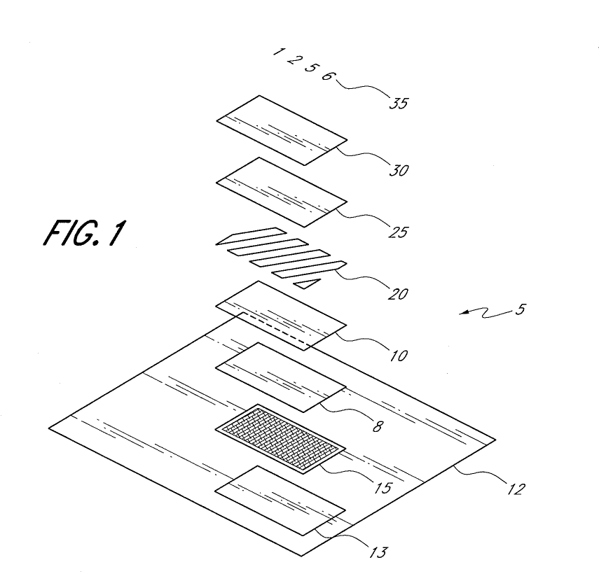

Referring to FIG. 1, a tamper evident form 5 is described. As shown, form 5 includes multiple layers which are configured to convey printed indicia 35 to an intended user. While form 5 generally shows multiple layer configurations, it is understood that this figure is an exploded view of the layers and that the layers collectively form one sheet. In addition, the form may be configured to have only a portion which contains the layers described herein. For example, a bank which conveys a confidential PIN number to a customer may only need to print the PIN on a small portion of the form. Thus, forms may be adapted to have portions which include the one or more layers further described herein.

Tamper evident form 5 may be used for conveying printed indicia 35 to an intended user who must take additional steps to actually view printed indicia 35. Tamper evident form 5 includes various security features which provide evidence that the form 5 has been tampered with if an attempt to obtain or view printed indicia 35 through certain surreptitious means has occurred. Such security features are present in the one or more layers of form 5.

Tamper evident form 5 includes one or more functional layers. Tamper evident form 5 includes a transparent lamina 10, a breakaway layer 20, a solvent reactive layer 25, and a heat reactive layer 30 that receives indicia positioned above scrambling layer 15. The function of scrambling layer 15 is to render printed indicia on one or more of the upper layers unreadable. Since the breakaway layer, 20, solvent reactive layer 25, and heat reactive layer 30 are each substantially transparent layers, printed indicia 35 is hidden from view by scrambling layer 15 while positioned above it.

Referring to FIG. 2, a top view of form 5 is shown. Printed indicia 35 is not visible when scrambling layer 15 is in place. The upper transparent lamina and one or more tamper evident coating layers are positioned above the scrambling layer. Form 5 may receive indicia from a printer, but such indicia would be not be readable without separation, alteration or negation of the scrambling layer 15 from the upper transparent lamina.

Scrambling layer 15 may be of any type or comprise any feature which prevents or substantially inhibits print on the one or more upper layers from being observed while positioned over the scrambling layer, assuming that the scrambling layer and the upper layers are still bonded together. In one embodiment, the scrambling layer includes a saturated mass of overprint alpha-numeric characters. In other embodiments, the scrambling layer may be comprised of other types of characters, random markings, or simply a darkly shaded or opaque area. In one embodiment, the scrambling layer 15 may include a scratch-off coating material.

In some embodiments, scrambling layer 15 or a portion of the scrambling layer may be negated or optically altered. For example, the scrambling layer may contain a pattern that renders the printed indicia 35 unreadable. However, a change to the scrambling layer, whether by its removal or physical alteration may render printed indicia readable. In one embodiment, the scrambling layer may be rotated or flipped to render the indicia readable. In another embodiment the scrambling layer is made of a disappearing ink or substance that can be physically or chemically altered or negated so that it no longer hides the printed indicia 35. In another embodiment the scrambling layer is made of a color changing ink or substance that can be physically or chemically altered so that it no longer hides the printed indicia 35.

In some embodiments, scrambling layer 15, or a portion of the scrambling layer 15, may be removed by peeling the layer or the portion away to reveal the printed indicia on the one or more upper layers. In certain embodiments, an optional release layer 8 may be disposed between the scrambling layer 15 and the transparent lamina 10 to facilitate the removal of the scrambling layer 15 from the transparent lamina 10.

Various peel away scrambling layers and the transparent lamina 10 are described in U.S. Pat. Nos. 6,220,633, 6,231,082, and 6,481,753. As shown in FIG. 1, substrate 12 has a portion 13 positioned below scrambling layer 15. In some embodiments, scrambling layer 15 is adhered to portion 13 with a suitable adhesive material. Portion 13 may be configured to be removable from substrate 12, such as die cuts, perforations and the like. Such removal may occur by peeling portion 13 and scrambling layer 15 from upper transparent lamina 10.

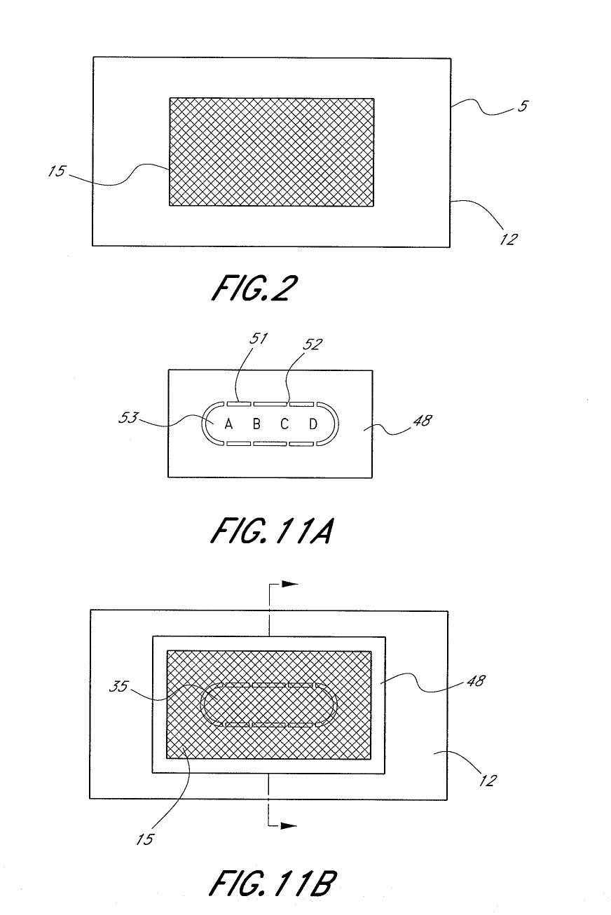

In one configuration, referring now to FIGS. 3A and 3B, there are illustrated sequential sectional views of one configuration of the upper layers 48, which includes the transparent lamina 10 and one or more upper coating tamper evident layers (e.g., the heat reactive layer 30, the solvent reactive layer 25, and/or the breakaway layer 20) or generally any layer positioned about the transparent lamina 10 include an upper surface layer which is printable, in combination with the scrambling layer 15 and the substrate 12 or a portion of the substrate 13. It will be appreciated that the thickness of the form is greatly exaggerated. In fact, the form is thin enough to pass through a conventional laser printer.

In one configuration, referring to 3A and 3B, upper layers 48 are adhered to substrate 12 by virtue of adhesive layer 11. A release layer 18 (e.g., silicone) is provided intermediate adhesive layer 11 and substrate 12 so that the removable portion of the upper layers 48 may be easily removed as shown in FIG. 3B carrying with it a portion of adhesive layer 11. A similar structure to that shown in FIGS. 3A and 3B (not illustrated here) avoids the use of die cuts and comprises an arrangement that is peeled from the top. For example, such an embodiment can comprise substrate 12 with scrambling means 15 above it and above that transparent layer 10. An adhesive layer above the transparent layer bears one or more of the heat reactive layer 30, solvent reactive layer 25 and break away layer 20. Peeling the layers above the transparent layer can provide an indication of tampering.

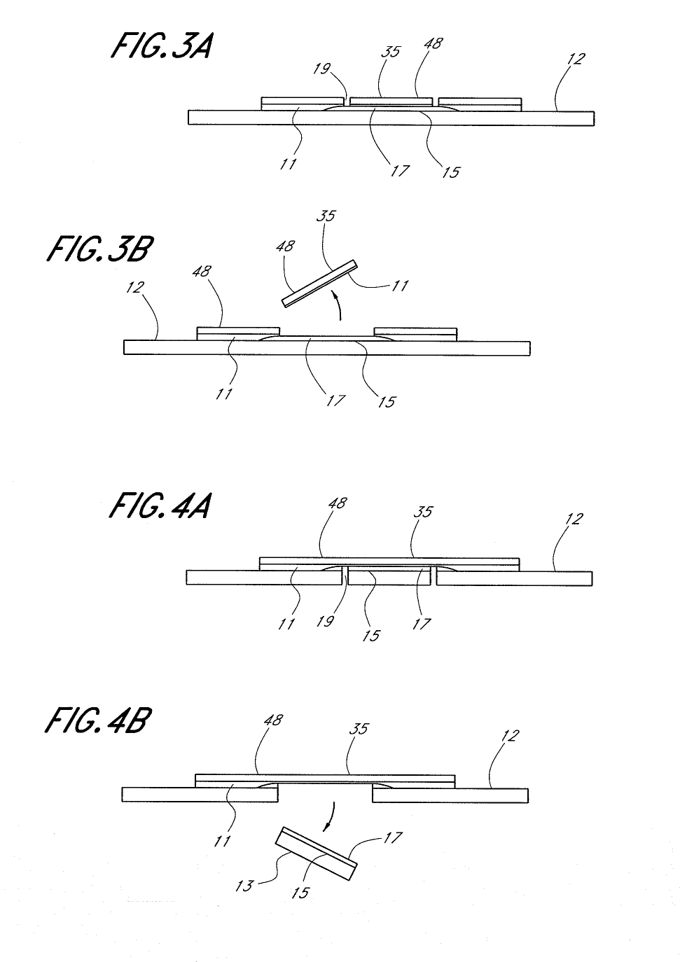

In another configuration, referring now to FIGS. 4A and 4B there is illustrated a form comprised of a substrate 12 and a transparent or translucent upper layers 48 adhered together by a layer of adhesive 13. However, in this case a die cut 19 is provided in the substrate 12 rather than in the upper layers and the die cut extends through release layer 17. Accordingly, a portion 13 of the substrate 12 is removable from the form as shown in FIG. 4B, rather than the upper layers 48 being removable from the form. It will be noted that die cut 19 may be a complete die cut or a perforated die cut with frangible ties and its purpose is to provide the recipient access to the scramble pattern 15 which would otherwise be sealed off by substrate 12. It will also be noted that portion 13 may be removed during the manufacturing of the form 5 or may be retained with the form for the intended recipient to remove. It is also noted that die cut 19 may be cut to form a perforated flap of substrate 12 so that the recipient can fold back 13 to remove, disable or negate scrambling layer 15, and then fold 13 back into position under the 48 to assist with the reading of the indicia 35.

It will be noted that a layer of adhesive 11 may be used to bond the upper layers 48 to the substrate 12. A release layer 17 is also provided to enable the portion of the substrate to be removed as shown in FIG. 4B. The die cut 19 extends through release layer 17 and therefore the release layer 17 is removed with the portion 13 of the substrate 12 as shown in FIG. 4B.

In some embodiments, the removed portion 13 of the substrate 12 can be flipped or rotated through 180 degrees so that the substrate 12 is above the release layer 17. The removed portion 13 of substrate 12 can then be replaced if desired, which may allow for easier reading of the revealed printed indicia 35.

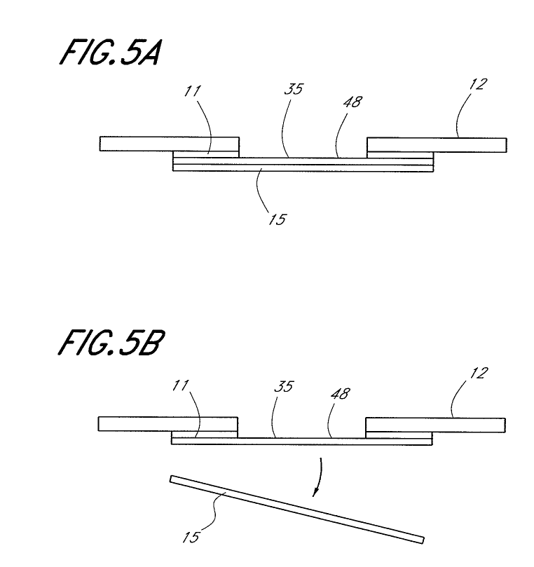

In another configuration, referring now to FIGS. 5A and 5B there is illustrated sequential sectional views of another embodiment. In this embodiment, the form comprises upper layers 48 and scrambling layer 15 adhered beneath the substrate 12. Scrambling layer 15 can be scratched away or peeled away as shown in FIG. 5B.

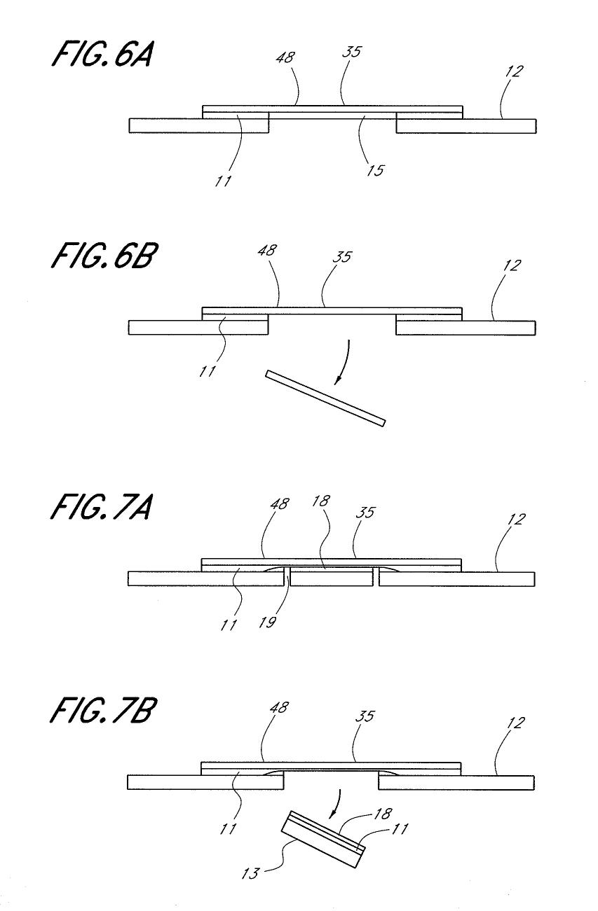

In another configuration, referring now to FIGS. 6A and 6B, there is illustrated sequential sectional views of another embodiment of a form. Again, there is a substrate 12 and upper layers 48. In this case, the substrate 12 has an aperture or hole provided beneath upper layer 48. Upper layers 48 are adhered to the substrate 12 by virtue of adhesive 11, which in this case is provided around the perimeter of the underside of the upper layers 48. Within the “ring” of adhesive 11 is provided a removable scrambling layer 15. In another embodiment, the adhesive layer 11 is continuous and the scrambling layer 15 is applied to the underside of the continuous adhesive layer 11.

In another configuration, referring now to FIGS. 7A and 7B, there is shown sequential sectional views of another embodiment. The form of this embodiment is comprised of substrate 12, adhesive layer 11, scrambling layer 15 and upper layers 48. In this case, the die cut 19 extends through the substrate 12, adhesive 11 and a release layer 18, although this embodiment could be die-cut from the upper side with the die cut extending through the upper layers 48 such that the upper layers 48 are removable.

In another configuration referring now to FIGS. 8A and 8B there is illustrated sequential sectional views of another embodiment. In this embodiment, adhesive layer 11 and release layer 18 have been reversed. Such form consists of a substrate 12, adhesive layer 11, release layer 18 and upper layers 48. As shown, the die cut 19 extends from the underside through the substrate 12 and adhesive 11, although the die cut 19 could extend from the upperside through the lamina and release layer. This embodiment can have the scrambling pattern either printed on the substrate 12 (as shown) or on the underside of the release layer 18 with the print being removed from the release layer 18 by the adhesive 11.

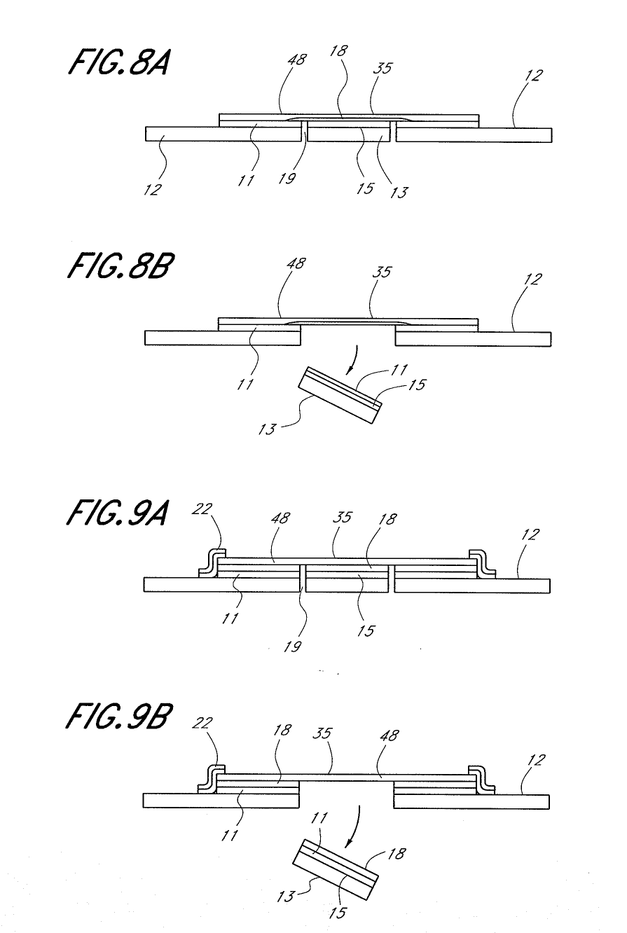

In another configuration, referring now to FIGS. 9A and 9B, there is illustrated sequential sectional views of another embodiment. This embodiment additionally includes a “frame” 22 which is adhered to the perimeter of upper layers 48 and to substrate 12 by virtue of adhesive 11. This “frame” 22 ensures that the edge of upper layers 48 cannot be lifted thereby ensuring that upper layers cannot be removed, viewed, and then replaced.

Referring to FIG. 10, in some embodiments, the scrambling pattern 37 may be printed on the upper surface of the substrate 12, if the substrate 12 or a portion 13 is separable from the upper layers 48 and release coating 18. In another embodiment, bottom surface of release coating 18 may be contain the scrambling means 37 and may be removed from upper layers 48, thus revealing printed indicia 35.

As noted for some embodiments, scrambling layer 15 may include a scratch-off coating. Such coating may be scratched off from the bottom surface of the scrambling layer to reveal printed indicia on one or more of the upper surfaces of the form 5.

In certain embodiments, transparent lamina 10 and the upper coating layers may be separated from form 5. Such separation functions to separate the scrambling layer 15 from the printed indicia 35, thus revealing the confidential information printed on the upper coating layers. In one embodiment, the transparent lamina 10 may also be bonded to the form through frangible ties. Upon removing the transparent lamina and the upper coating layers containing the printed indicia, the frangible ties may be broken. As such, frangible ties may also be provided in any of the disclosed embodiment as an additional security feature.

Referring to FIG. 11A, upper coating layers 48 are transparent or translucent and includes an incomplete or perforate die cut 51 defining within the die cut a removable portion of the upper layers. The incomplete die cut 51 leaves ties 52 whereby the removable portion of the upper layers (in this case having the printed indicia thereon) remains connected to the remainder of the upper layers 48. The ties 52 are frangible such that the portion of the upper layers carrying the printed indicia may be removed from the remainder of the upper layers 48 and such removal is tamper-evident by virtue of the broken ties. Removal of the portion of the lamina is facilitated by the provision of tabs 53 which can be manually lifted and grasped.

Referring now to FIG. 11B, there is illustrated a first embodiment of the invention in which the upper layers 48 have been adhered about its perimeter to a substrate 12 carrying a scrambling means. It will be understood that any information printed on the transparent or translucent lamina 48 cannot be ascertained due to the fact that the information is superimposed on the scrambling layer 15.

Further disposed on the upper surface of transparent lamina 10 are one or more tamper evident layers and/or one or more layers adapted to received printed indicia. As shown, a breakaway layer 20 is an intermittent, diagonal pattern in contact with transparent lamina 10. Such pattern may be configured to be easy release. The breakaway layer 20 functions to selectively adhere lightly to the transparent lamina 10 in a manner such that the breakaway layer may be peeled away from the transparent lamina in areas of light bond or easy release and adheres tightly in areas of non release. This can be accomplished through the use of a release coating in used in defined areas between the transparent lamina and the upper layers. In areas of non release or tight bond, the transparent lamina 10 will continue to bond strongly to the solvent reactive layer 25. Thus, where there is tight bonding of the transparent lamina 10 by the breakaway layer 20, the solvent reactive layer 25 will adhere to the transparent lamina 10. The release layer can also cover up to 100% of the surface of the transparent lamina.

Breakaway layer 20 is configured to adhere strongly to solvent reactive layer 25. Such adherence must be greater than the adherence of the upper layers to the transparent lamina 10. Likewise, solvent reaction layer 25 is adhered strongly to heat reactive layer 30. Such adherence must be greater than the adherence of the breakaway layer 20 to the transparent lamina 10. This adhesion relationship is preferable in causing the breaking away of the one or more upper layers and the breakaway layer in the event of attempts to lift the upper surface 31 of the form from the scrambling means.

In areas of the upper surface of the transparent lamina 10 that are not coated with breakaway layer 20, the adhesion of the transparent lamina 10 must have sufficient adhesion to the solvent reactive layer 25 in order to not be released with the release of the breakaway layer 20. The adhesion between the transparent lamina 10 and the breakaway layer 20 should preferably have the weakest adhesion of all the bonds in the construction. This allows for all layers above breakaway coating 20 to be pulled away together. The adhesion of the solvent reactive layer 25 to the transparent lamina 10 is preferably also greater than the intra-layer bonding of the solvent reactive layer 25. This allows only a portion of the solvent reaction layer 25 to be torn away in the event that the breakaway layer 20 is peeled from the transparent lamina 10. In some embodiments, the heat reactive layer 30 should have similar adhesion characteristics such that the intra-layer bonding of the heat reactive layer 30 is less than the adhesion of the heat reactive layer 30 to the solvent reactive layer 25. With such adhesion characteristics, when sufficient peel force is applied to the upper surface 31, the breakaway layer 20 causes a breaking away of the solvent reaction layer 25 and the heat reactive layer 30, but only in portions of such layers positions above the coverage of the breakaway layer 20.

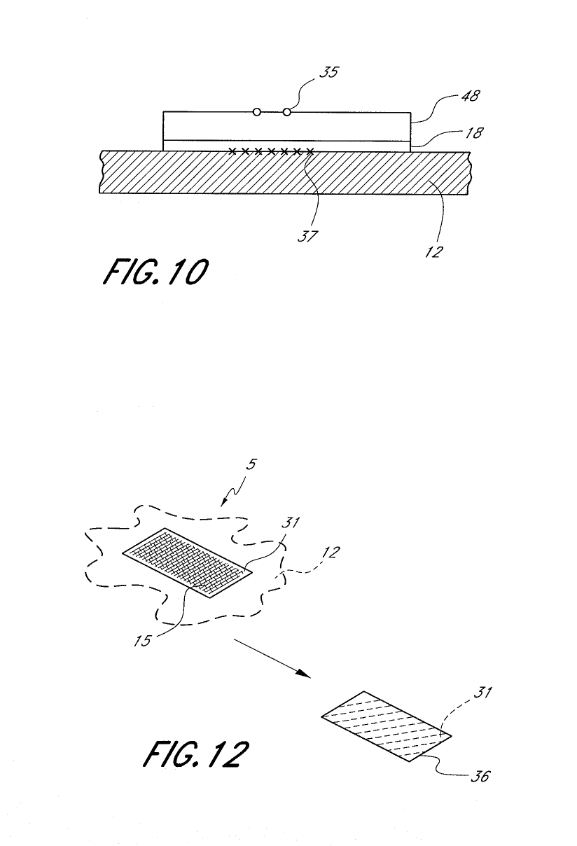

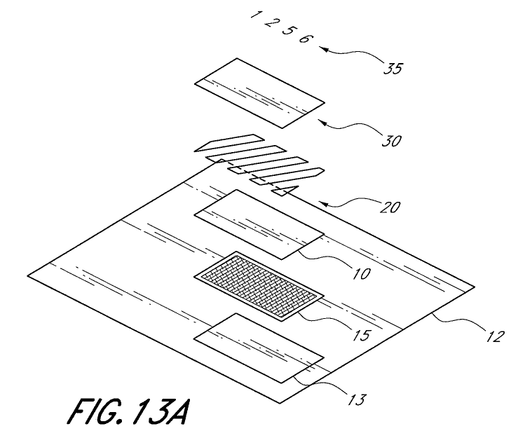

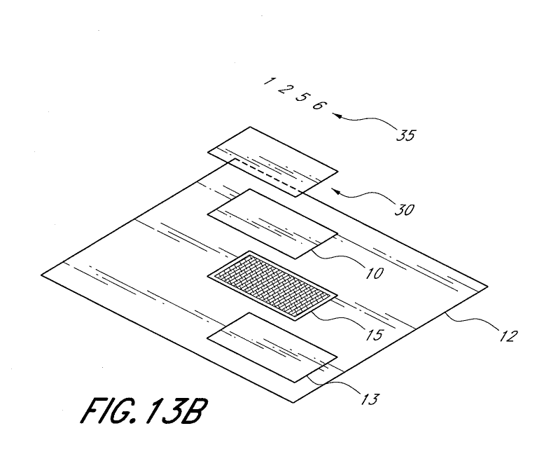

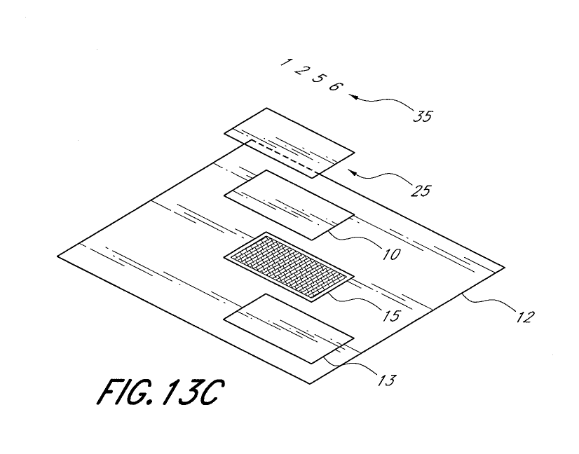

Advantageously, the breaking away of portions of the upper surface 31 functions to destroy the printed indicia. Referring to FIG. 12, a top view of form 5 is shown. While indicia may be printed on the upper surface 31, the indicia are not readable because of the presence of the underlying scrambling layer 15. Attempted removal of the upper surface 31 results in the break-away of the breakaway layer 20 and the portions of the solvent reaction layer 25 and the heat reaction layer 30 positioned above the breakaway layer. The tearing of the upper surface 31 causes the printed indicia 35 to be unreadable in a portion 36 which is broken away from form 5. If the scrambling means 15 is then removed, only a portion of printed indicia 35 will remain thus evidencing tampering of the form.

Solvent reactive layer 25 is adhered between breakaway layer 20 and heat reactive layer 30. Generally, the solvent reactive layer is a layer which undergoes a chemical change upon exposure to solvents. While solvent attack may be used from the upper surface 31, it is believed that the heat reactive layer 30 is sufficiently permeable such that the solvent is conveyed to the solvent reactive layer 25. However, it also contemplated that the materials of the heat reactive layer 30 may be included on or near the printed indicia. Such configuration may allow immediate chemical change upon the surface and function to be less independent on the permeability of the heat reactive layer 25. It is contemplated that layers can be formulated to have multiple functionality. For example, the solvent reactive layer can be formulated to have breakaway properties or heat reactive properties.

A heat reactive layer 30 is adhered to the upper surface of the solvent reactive layer 25. The heat reactive layer 30 may be configured to receive printed indicia. Printed indicia 35 may be received on the upper surface 31 of heat reactive coating 30. In some embodiments, heat reactive layer 30 may comprises one or more layers or printable components coated on the upper surface 31 which are configured to receive printed indicia. In certain embodiments, additional components are not required as the composition forming the heat reactive layer 25 is suitable for receiving indicia 35.

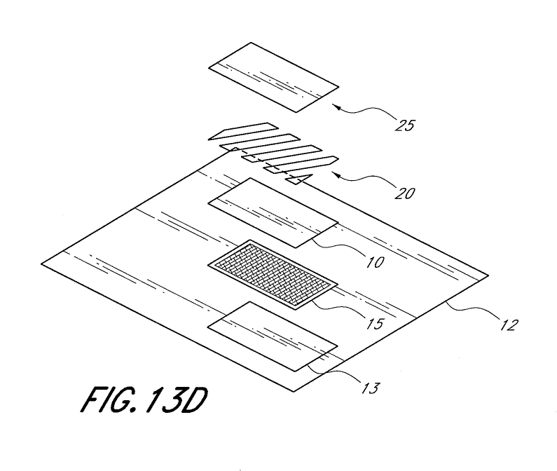

FIG. 1 represents that a breakaway layer 20, a chemically reactive layer 25, and a heat reactive layer 30 are adhered to the upper surface of the transparent lamina 10 in a certain configuration. Such additional coating layers are tamper evident layers as they provide evidence of tampering by an unintended user who may use chemical or physical means in an attempt to read or remove printed indicia 35. While these layers are presented in FIG. 1 in a preferred configuration, it is understood by persons having ordinary skill in the art that such layers may be used in any number of various configurations. For example, one or more layers may be optional layers and not included in every embodiment. FIGS. 13A-13E describe other various layer configurations of certain embodiments.

Referring to FIG. 13A, one embodiment includes a form 6 having a scrambling layer 15, a transparent lamina 10, breakaway layer 20, and a heat reactive coating 30 adhere together. Compared to the embodiment of FIG. 1, the form 6 does not contain a solvent reactive layer 25. In some embodiments, components of a solvent reactive layer may be incorporate into the heat reactive coating 30 in order to combine two security features in a single layer. Heat reactive layer 30 is capable of receiving printed indicia 35.

Continuing to refer to FIG. 13A, breakaway layer 20 is shown as having partial coverage over transparent lamina 10. In this embodiment, portions of heat reactive layer 30 are adhered directly to transparent lamina 10 and portions of heat reactive layer 30 are adhered to breakaway layer 20. Preferably, the adherence of the heat reactive layer 30 to transparent lamina 10 is greater than the adherence of the breakaway layer 20 to the transparent lamina 10. In addition, the intra-layer bonding of heat reactive layer 30 is less adhesive that adhesion of breakaway layer 20 to heat reactive layer 30. As such, a sufficient peel force applied to the upper surface 31 of form 6 will result in the breakaway of the breakaway layer 20 from transparent layer 10. In certain embodiments, the peel force will also destroy printed indicia since the intra-layer bonding of the heat reactive layer 30 will break with the release of the breakaway layer 20. Preferably, this tearing of the heat reactive layer will irreversibly render printed indicia 35 unreadable and/or will provide tamper evidence.

Continuing to refer to FIG. 13A, it is believed that heat reactive layer 30 also functions in a coordinate manner with breakaway layer 20. Attempts to transfer printed indicia 35 through the application of heat and a transfer medium (film or paper) may include pressing the medium down on the upper surface 31 of the heat reactive layer 30 with heat sufficient to fuse a portion of the transfer medium and the heat reactive layer 30. Removal of the transfer medium may have sufficient peel force to cause the breakaway layer 20 to break away from the transparent lamina 10 and tearing of the intra-layer bonding of the heat reactive layer 30. As such, the removal of the transfer medium may tear the printed indicia 35 and render it unreadable and/or tamper evident.

Referring to FIG. 13B, one embodiment includes a form 7 having a scrambling layer 15, a transparent lamina 10, and heat reactive coating 30 adhered together. Compared to the embodiment of FIG. 1, the form 7 does not contain a breakaway layer 25 or a solvent reaction layer 25. As such, the heat reactive layer 30 is bonded directly to the transparent lamina 10. The heat reactive layer may be designed to cover the entire surface of the transparent lamina 10 or may cover the entire surface 30. Heat reaction layer 30 may be configured to receive printed indicia 35.

Referring to FIG. 13C, one embodiment includes a form 8 having a scrambling layer 15, a transparent lamina 10, and solvent reactive layer 25 adhered together. Compared to the embodiment of FIG. 1, the form 8 does not contain a breakaway layer 20 or a heat reaction layer 30. In this embodiment, printed indicia 35 is printed on the solvent reactive layer 25. Solvent reaction layer 25 may be designed to cover the entire surface of the transparent laminate 10 or a portion thereof.

Referring to FIG. 13D, one embodiment includes a form 9 having a scrambling layer 15, a transparent lamina 10, a breakaway layer 20, and a solvent reactive layer 25 adhered together. Compared to the embodiment of FIG. 1, form 9 does not contain a heat reactive layer. In this embodiment, solvent reactive layer 25 is configured to receive printed indicia.

Continuing to refer to FIG. 13D, breakaway layer 20 is shown as having partial coverage over transparent lamina 10. In this embodiment, portions of solvent reactive layer 25 are adhered directly to transparent lamina 10 and portions of solvent reactive layer 25 are adhered to breakaway layer 20. Preferably, the adherence of the solvent reactive layer 25 to transparent lamina 10 is greater than the adherence of the breakaway layer 20 to the transparent lamina 10. In addition, the intra-layer bonding of solvent reactive layer 25 is less adhesive that the adhesion of breakaway layer 20 to solvent reactive layer 25. As such, a sufficient peel force applied to the upper surface 31 of form 9 will result in the release of the breakaway layer 20 from transparent layer 10. In certain embodiments, the peel force will also destroy printed indicia 35 since the intra-layer bonding of the solvent reactive layer 25 will break with the release of the breakaway layer 20. Preferably, this tearing of the solvent reactive layer 25 will destroy printed indicia 35 and/or will provide tamper evidence of the peel.

The breakaway layer 20, the solvent reactive layer 25, and the heat reactive layer 30 is described in detail below in reference to FIG. 1. However, it understood that any of the breakaway layer 20, solvent reaction layer 25, and heat reactive layer 30 may be used alone or together with one or more of the other layers in any of the various embodiments of forms described herein.

### Breakaway Layer

One method used to obtain the printed indicia 35 from form 5 without removing the scrambling means 15 is to physically remove the upper surface 31 which carries the printed indicia 35. A surreptitious attempt may also include reapplication of the upper surface 31 to form 5 in order to not alert the intended recipient of tampering. In order to thwart such physical tampering, form 5 may contain a breakaway layer 20 disposed between the upper surface 30 and transparent lamina 10. Such breakaway layer 20 is designed to release in the pattern of the coating. Such release causes the release of coating layer 20 from transparent lamina 10 and tears upper surface 31 in the pattern of the breakaway layer 20. Such tearing provides tamper evidence that there was an attempt to remove the upper surface carrying the indicia, or even an attempt to remove at least a portion of the indicia itself as described below in reference to the heat reactive coating 30.

The breakaway layer 20 is thus designed to have less affinity to transparent lamina 10 on its lower surface than to the solvent reactive layer 25 on the breakaway layer's upper surface. As such, in one embodiment, the breakaway layer 20 is positioned between the transparent lamina 10 and the solvent reactive layer 25. In other embodiments, the breakaway layer is positioned between the transparent lamina 10 and the heat reactive layer 30. In such embodiment, the breakaway layer is adapted to have greater adhesion to the heat reactive layer 30 than to the transparent lamina 10. In another embodiment, the breakaway layer 20 is positioned between the transparent lamina 10 and a printable layer, such as solvent reactive layer 25, heat reactive layer 30, or any other layer which may be adapted to receive printed indicia 35.

In some embodiments, the upper surface of the breakaway layer 20 may be surface treated to increase the adhesion of the upper surface of the breakaway layer 20 with the above layer, the solvent reactive layer 25. In some embodiments, the surface treatment may include one or more selected from the group consisting of heat treatment, flame treatment, corona treatment, plasma treatment, and the like. In one preferred embodiment, the upper surface of the breakaway layer is corona treated.

In some embodiments, the breakaway layer 20 may be applied to approximately 1 to about 100 percent of the upper surface area of the transparent lamina 10. In some embodiments, the breakaway layer 20 may be applied to approximately 30 to about 70 percent of the upper surface area of the transparent lamina 10. In some embodiments, the breakaway layer 10 may be applied to approximately 40 to about 60 percent of the upper surface area of the transparent lamina 10. In some embodiments, the breakaway layer 20 may be applied to approximately 50 percent of the upper surface area of the transparent lamina 10.

Breakaway layers may be applied on the upper surface of the transparent layer 10 in various patterns and or shapes. In one embodiment, the release coating is applied in a diagonal, striped line pattern, the line having certain widths which are configured to prevent the printed indicia 35 from being read if the breakaway layer 20 is peeled away and the upper surface 31 is torn. In some embodiments, the breakaway layer 20 is adapted to render the printed indicia 35 unreadable on a portion that is broken from the tamper evident form 5 in the event of physical tampering.

In one embodiment, the breakaway layer is applied as a series of lines. In some embodiments, the breakaway layer is applied as a series of diagonal lines having certain dimensions. Between the diagonal lines are areas where the breakaway layer 20 is not applied. In some embodiments, the lines are about 0.2 to about 0.3 inches wide. In some embodiments, the diagonal line repeats 0.4 to about 0.6 inches between the center of one diagonal line to center of an adjacent diagonal line. The lines may be applied in a substantially parallel or parallel direction. In some embodiments, the gap between each line in a direction perpendicular to the length of the lines is between about 0.2 to about 0.3 inches.

Advantageously, the breakaway layer thus provides evidence that the printed indicia 25 has attempted to be viewed and also functions to destroy the printed information in the event of attempted removal of the upper surface 31.

The composition of the breakaway layer material preferably has sufficient adhesion to prevent delamination of the breakaway layer 20 from the transparent lamina 10 during normal processing of form 5. However, such adhesive composition must also maintain its breakaway properties under a surreptitious peel force of the upper layer 31. In some embodiments, the breakaway layer 20 has a peel force of between about 10 to about 200 grams/inch of width, and preferably has a peel force between about 20 to about 50 grams/inch of width. In some embodiments, the breakaway layer has a peel force of about 20 to about 40 grams/inch of width. In some embodiments, the breakaway layer has a peel force of about 30 to about 50 grams/inch of width. In some embodiments, the breakaway layer has a peel force of about 10 to about 25 grams/inch of width.

In certain embodiments, the amount of force required to tear start peeling the breakaway layer may depend on a variety of factors. For example, one factor is the peel force of the breakaway layer. Another factor may be the intra-layer bonding of one or more layers positioned above the breakaway layer. In certain embodiments, the force required to initiate the break of the breakaway layer and the one or more layers above the breakaway layer away from the tamper evident form is a force that is about 1.5 to about 4 times greater than the peel force of the breakaway layer. In certain embodiments, the force required to initiate the break of the breakaway layer and the one or more layers above the breakaway layer away from the tamper evident form is a force that is about 2 to about 3 times greater than the peel force of the breakaway layer. In certain embodiments, the force required to initiate the break of the breakaway layer and the one or more layers above the breakaway layer away from the tamper evident form is a force that about 3 times greater than the peel force of the breakaway layer.

In certain embodiments, the thickness of the breakaway layer 20 is sufficiently thick to prevent rupture if breakaway layer 20 is flexed, but sufficiently thin in order to delaminate the breakaway layer 20 with the attempted removal of the carrier film 30. In some embodiments, the breakaway layer has a thickness of between about 0.05 to about 0.5 mil. In some embodiments, the breakaway layer has a thickness of between about 0.15 to about 0.3 mil. In some embodiments, the breakaway layer has a thickness of between about 0.1 to about 0.35 mil. In some embodiments, the breakaway layer has a thickness of between about 0.15 to about 0.25 mil. In some embodiments, the breakaway layer has a thickness of between about 0.2 to about 0.3 mil. In some embodiments, the breakaway layer has a thickness of between about 0.1 to about 0.4 mil.

In some embodiments, it is preferred that such release layer be substantially transparent or have a refractive index substantially the same as the refractive index of the layer or combined layers above the release layer to avoid detection by the naked eye. As such, the breakaway layer 20 functions as a covert security feature of form 5.

In some embodiments, a suitable release layer is at least one polymer having a glass transition temperature of between about 0 and 10° C. In some embodiments, the release layer is at least one polymer having a glass transition temperature of between 25 to about 75° C. In some embodiments, a suitable release layer is a polymer having a glass transition temperature of between about 20 and 40° C. However, it understood that a suitable polymer may have a glass transition temperature lower than or greater than the aforementioned values.

Preferred breakaway materials having suitable adhesion and transparent properties include silicone release coatings, such as Syl-Off 23, available from Dow Corning (Midland, Mich.). Other materials may also include polymer and release agent blends that exhibit preferential adhesion and low peel bonds, such as FAL100, available from Process Resources Corp. (Thornwood, N.Y.).

### Heat Reactive Layer

Another method commonly used to obtain the printed indicia 35 from form 5 without removing the scrambling means is by applying heat to the printed indicia 35 in order to lift the printed indicia onto a transfer medium, such as a film or paper, between the heat source and the upper layer 31. Typically, the heat required to cause the transfer of the toner ink to a transfer medium is about 150° F. for a dwell time of greater than 3 second at 10 psi. It is understood that transferring the toner or ink to a transfer medium shall require a combination of temperature, dwell time and pressure. Higher temperatures require relatively less dwell time and pressure than lower temperature. All three components must be viewed together to determine the amount of each that will be required to transfer some or all of the indicia. Such thermal transfer of the printed image may be thwarted by using form 5 having the heat reactive layer 30.

Heat reactive layer 30 is configured to provide a surface which may receive printing from a laser or ink-jet printer. As such, the heat reactive layer 30 may be adapted to be the upper surface 31 of form 5. In this embodiment, the lower surface of the heat reactive layer 30 is solvent reactive layer 25 However, in some embodiments, the lower surface of heat reactive layer 30 is adjacent to breakaway layer 20. In some embodiment, the lower surface of heat reactive layer 30 is adjacent the transparent lamina 10.

While heating may occur in the printer, the surface of the heat reactive layer 30 would substantially be unaltered while exposed to the heating element of a printer. The process conditions of printers require that the heating element come into contact with the surface of form 5. Such heating elements have a temperature ranging from about 150 to about 550° F. Some printers' heating elements are even cooler being less than 150° F., less than 125° F., or less than 100° F. The dwell time of the heating element under pressure on the upper surface 31 of heat reactive layer 30 is less than or about 1 second, typically between 1 and about 100 ms. Moreover, the heating element may apply pressure with the heat. The typical pressure of a laser jet printer ranges from about 1 to about 100 psi, and more preferably between about 30 and about 40 psi. For example, the IBM 3800 printer applies fixes the toner with its heating element at a temperature between 179° C. to 218° C., under 35 psi, and a dwell time of 11 ms.

The heat reactive layer 30 is adapted to withstand such upper surface conditions during printing, remaining substantially unchanged. However, heat reactive layer 30 is also configured to provide a surface which softens and flows when exposed to temperatures above 130° F., or even above 150° F., at dwell times of greater than 3 seconds at pressures greater than 10 psi. Such conditions are typical of those used in attempts to transfer the toner to a film with heat and pressure. According to some embodiments, the heat reactive layer 30 may be adapted to soften and/or fuse with a transfer medium between the upper surface 31 and a heat source if the heat source has a temperature of greater than 150° F. at dwell times of greater than 3 seconds at greater than 10 psi. However, the various pressures, temperatures and dwell times may be different if one of the factors is changed.

Once at least partially fused, transfer medium may not be removed from the heat reactive layer 30 without providing evidence of the transfer. Once fused, the transfer medium may actually tear leaving behind portions of the transfer medium in the heat reactive layer 30. In some embodiments including breakaway layers, removal of the transfer medium may be sufficient peel force to cause the breakaway of the breakaway layer 20 and destruction of the printed indicia 35.

In some embodiments, the heat reactive layer 30 includes one or more polymers. Selection of the polymeric materials of the heat reactive layer 30 provides a layer which may fuse with a paper or film substrate at a temperature of above 120° C. for about 3 seconds. Suitable polymeric materials and mixtures of polymeric materials may be selected based on the glass transition temperature (T_{g}) of the polymers of the layer.

In one embodiment, the heat reactive layer 30 includes a first polymeric material having a first glass transition temperature between about −20 and about 20° C., and a second polymeric material having a second glass transition temperature of greater than about 20° C. In certain embodiments, the second glass transition temperature ranges from about 25 to about 90° C. In certain embodiments, the second glass transition temperature ranges from about 25 to about 35° C. In certain embodiments, the second glass transition temperature ranges from about 45 to about 75° C. In certain embodiments, the second glass transition temperature ranges from about 50 to about 80° C. In certain embodiments, the second glass transition temperature ranges from about 35 to about 55° C.

In certain embodiments, the first polymeric material is about 40 to about 60 parts by weight, and the second polymeric material is about 40 to about 60 parts by weight, relative to the total weight of the first and second polymeric materials being 100 parts. In certain embodiments, the first polymeric material is about 45 to about 55 parts by weight, and the second polymeric material is about 48 to about 52 parts by weight, relative to the total weight of the first and second polymeric materials. In certain embodiments, the first polymeric material is about 50 parts by weight, and the second polymeric material is about 50 parts by weight, relative to the total weight of the first and second polymeric materials.

In certain embodiments, the first polymeric material may be selected from the group consisting of an acrylic, a urethane, a polyester, or a vinyl based polymer, such first polymeric material having a glass transition temperature as defined above. In certain embodiments, the second polymeric material may be selected from the group consisting of an acrylic, a urethane, a polyester, or a vinyl based polymer, such first polymeric material having a glass transition temperature as defined above

In certain embodiments, the heat reactive layer 30 includes the first polymeric material, the second polymeric material, and filler particles configured to buffer the heat reactive layer 30 from short term exposure to heat such as through the printer. Suitable filler particles may be selected from one or more of china clay, calcium carbonate, titanium dioxide, talc, and the like.

In some embodiments, the heat reactive layer 30 comprises between about 10 to about 35 dry weight percent of the filler particles. In some embodiments, the heat reactive layer 30 comprises between about 20 to about 25 dry weight percent of the filler particles. In certain embodiments, the amount, type, shape, and size of filler particle may vary. For example, the particle may be selected to be of platelet shaped or acicular. Also, filler particles sizes may vary. In certain embodiments, the average particle size of the filler particles is up to about 12 microns.

In some embodiments, the heat reactive layer comprises a filler material adapted to provide translucence or transparency to the layer. While many filler particles are opaque except for the prisms described below in the anti-scanning properties, various particles sizes and packing of such particles upon drying of the coating results in the film being substantially transparent. In one embodiment, a blend of particles having a particle size of less than 1 micron may contribute to the flattening of the particles in the layer, while larger platelet type particles provide protection against fusion to the fusing drum of the printer.

In one preferred embodiment, the particles are magnesium silicate and calcium silicate platelet and acicular shaped particles. Such particles have a particle size of between about 3 to about 8 microns.

In another preferred embodiment, a blend of about 50 weight percent of calcium carbonate particles having particles sizes less than about 1 micron may be mixed about 50 weight percent of the platelet sized talc, based on the total of particles being about 100 weight percent. In some embodiments, a portion of the calcium carbonate particles may be replaced with titanium dioxide particles to provide a whitening effect to decrease a color change caused by incorporation of talc and yellowing of the polymers on aging or heat exposure used to make up the layers above the transparent lamina.

In certain embodiments, at least some of the filler particles are disposed near the upper surface 31 of the heat reactive layer 30. Advantageously, the filler particles thus serve as a physical separation buffer between the fusing drum of the printer (e.g., the heating element) and the first and second polymer materials. In some embodiments, the particles may be adapted to bond to the toner of the printed indicia on the surface of the form. In one embodiment, the particles are arranged such that they provide a receptacle for the toner ink. In certain embodiments, the particles provide a concave area which receives the toner ink of the printed indicia.

In some embodiments, the particles are configured to reduce surface contact between the one or more polymers in the upper layer and the fusing section of a printer which prints indicia 35 to the upper surface 31.

One advantage of incorporating such particles into the heat reactive layer is that the particles may provide a matte finish to the upper surface 31 of the heat reactive layer. Such matte finish renders the printed indicia more difficult to read at different lighting angles. Preferably, heat reactive layer 30 having the filler particles is configured to have a gloss value at a 45 degree measured angle in a range of about 3 to about 16 gloss units, and preferably in the range of about 4 to about 8 gloss units. 20 degrees is our preferred angle for assessing the Pin number in angled light. The target range at a 20 degrees angle is from 1.5 to 3.5 Gloss Units with a preferred range of from 2.1 to 2.9 Gloss Units. For reference, at a 60 degree angle, the range from 9.1 to 12.1 throughout the run. Note that gloss measurements were taken with the film over a flat black background, because a reflective surface below a contact clear film where gloss is being measured makes a difference.

Commercial available materials for forming such heat reactive materials are available from Process Resources (Thornwood, N.Y.) as PD1010. Other additives may be incorporated into the heat reactive layer including, but not limited to, a wetting agent and a defoamer.

In some embodiments, it is desirable that the form include both heat reactive layer 30 and breakaway layer 20, as shown in FIGS. 1 and 3A. In this embodiment, upon exposure to sufficient heat and pressure the heat reactive layer 30 will bond to a film or paper being used to transfer the printed indicia 35. In some embodiments, such bond between the heat reactive layer 30 and the transfer means is stronger than the adhesion between the breakaway layer 20 and the transparent layer 30. The attempted removal of the transfer means from the heat reactive coating 30 released the breakaway layer 20 which destroys the printed indicia 35.

In another embodiment, the heat reactive layer 30 is configured to be solvent permeable. Exposure of the surface of the heat reactive layer 30 to a solvent results in the transfer of the solvent through the heat reactive layer into the solvent reaction layer 25. In certain embodiments, the heat reactive layer 30 comprises a portion of the materials used to form the solvent reaction layer 25. Without being bound to any particular theory, it is believed that by using the materials of the solvent reaction layer in the heat reactive layer, the solvent may better permeate the heat reactive layer 30 into the solvent reaction layer 25.

In certain embodiments, about 25 to about 75 weight percent of the heat reactive layer comprises the material used in the solvent reaction layer as described below. In certain embodiments, about 30 to about 65 weight percent of the heat reactive layer comprises the material used in the solvent reaction layer as described below. In certain embodiments, about 40 weight percent of the heat reactive layer comprises the material used in the solvent reaction layer as described below.

In certain embodiments, the heat reactive layer may have one or more other functionalities. In some embodiments, one of the polymeric materials used in the heat reactive layer may be adapted to be both heat reactive and solvent sensitive as described herein.

### Solvent Reactive Layer

Another method used to obtain the printed indicia 35 from form 5 without removing the scrambling means 15 is by application of a solvent to the upper surface 31, in conjunction with contacting a transfer medium with the upper surface 31. This method may result in transfer of a replica of the printed indicia to the transfer medium. In order to thwart such solvent transfer, form 5 may include a solvent reactive layer 25. Exposure of the solvent reactive layer 25 to a solvent changes the appearance of the solvent reactive layer 25. In some embodiments, exposure of the solvent reactive layer 25 to a solvent changes the transparency of the layer. In one embodiment, the layer is changed into a translucent and/or opaque layer.

Such optical changes of the solvent reactive layer are tamper evident. Once the scrambling layer 15 is separated from the transparent lamina 10, a translucent layer may prevent or interfere with observation of the printed indicia 35. Instructions may be provided to the intended recipient that a milky, translucent, opaque image is evidence of tampering.

Various compositions for forming solvent reactive layers on substrates are known. While it is contemplated that any of these may be incorporated into one or more of the herein described embodiments, a preferred embodiment includes a solvent reactive layer containing at least two components which when agitated together and applied as a homogeneous coating forms a substantially transparent solvent reactive layer 25. However, upon exposure to a solvent, one or more of the components of the solvent reactive layer 25 dissolves in the solvent and/or heterogeneously separates from the other components. As a result of this separation, the solvent reactive layer 25 changes from a substantially transparent coating to a more translucent coating which is visible to the naked eye. As such, a form having such solvent reaction layer 25 is tamper evident if exposed to a solvent.

According to some embodiments, components of the chemical reactive coating material are selected based on the difference in their miscibility when statically exposed to common solvents. However, such materials should be miscible upon agitation. Common solvents which are used for the coating solution and/or surreptitious detection may be one or more of water, alcohols, acetone, halogenated solvents such as dimethylene chloride or chloroform, alkanes such as pentane and hexane, aromatics such as benzene, and other commonly used solvents. In certain embodiments, one or more solvent reactive layers may be included in the form in order to be a multiple solvent tamper evident form. In some embodiments, one solvent reactive layer 25 may be adapted to react to alcohols and strong organic solvents.

In certain embodiments, a first polymer and a second polymer may be used to form the solvent reactive coating 25. In such embodiment, a first polymer may be selected to be soluble in a certain solvent and a second polymer may be selected to be insoluble or only partially soluble in the same solvent. Agitation of the first soluble polymer and second partially soluble or insoluble polymer (usually provided as an emulsion) provides a substantially homogeneous mixture of the first and second polymer in a coating solution. The solution may then be applied to one or more layers of the form and dried to produce the solvent reactive layer 25.

Exposure of the solvent reactive coating layer to a solvent results in precipitation of the second polymer. In some embodiments, the exposure produces a more translucent or even opaque solvent reactive coating layer 25. Separation of the scrambling layer 15 from the transparent layer 10 would clearly show that the form had been tampered with by the appearance of a haze or opacity in the form. In some embodiments, the printed indicia 35 would be unreadable because of this solvent reaction.

In certain embodiments, the solvent reactive coating comprises a first polymer in an amount from about 25 to about 75 weight percent and a second polymer is used in an amount from about 25 to about 75 weight percent, based on the total weight percent of the first and second polymers being about 100 percent. In certain embodiments, the solvent reactive coating comprises a first polymer in an amount from about 40 to about 60 weight percent and a second polymer in an amount from about 40 to about 60 weight percent, based on the total weight percent of the first and second polymers being about 100 percent. In certain embodiments, the solvent reactive coating comprises a first polymer in an amount of about 50 weight percent and a second polymer in an amount of about 50 weight percent, based on the total weight percent of the first and second polymers being about 100 percent.

According to some embodiments, the dry coat weight of the solvent reactive layer ranges from about 4 to about 12 g/m², and preferably about 6 to about 9 g/m². In some embodiments, the dry coat weight of the solvent reactive layer ranges from about 3 to about 6 g/m². In some embodiments, the dry coat weight of the solvent reactive layer ranges from about 5 to about 7 g/m².

Suitable incompatible components may be selected from polymer resins such as vinyl acetate, acrylics, urethanes, styrene, ethylene vinyl acetate copolymers, vinyl chlorides, polycarbonates, or polyesters. Such resins may be selected for incompatibility based on their solubility in a particular solvent or in multiple solvents.

While the solvent reactive layer may be used in a single coating layer as shown in FIG. 1, it is also contemplated that other various methods may be used to incorporate the components of the solvent reactive layer into one or more of the functional layers such as the heat reactive layer and/or the breakaway layer. In certain embodiments, the solvent reactive layer may be configured such that it is near or at the upper surface 31 in order to be sensitive to solve attacks on the printed indicia 35.

In some embodiments, the solvent reactive layer is present in various layers or at various heights such that it is more sensitive to the exposure of the surface to the form to solvents.

### Anti-Scanning/Coping Additives

Optical methods for observing the printed indicia 35 without removing the scrambling layer 15 also exist. Simple observation and backlighting are methods easily thwarted by using scrambling layer 15. However, more advanced techniques include low powered microscopy and optical scanning and copying together in conjunction with computer image manipulation. These more advanced techniques may be thwarted by incorporating anti-scanning particles or beads into one or more layers of the form 5. In some embodiments, the anti-scanning particles are dispersed near or at the upper surface 31 of form 5. In some embodiments, the anti-scanning particles are located adjacent to the surface which receives printed indicia.

Anti-scanning particles are materials that transmit, reflect, and/or refract light. By suspending or affixing these particles in one of the layers, such as the surface layer wherein the printed indicia is received, it is possible to protect the form from copy replication of the printed indicia. When the form is illuminated by a scanner or copy apparatus, the anti-scanning particles refract the light and jumble the reflected image of the printed indicia so that it is not reflected back properly to the reader rendering the image unreadable by a scanner or copier.

In some embodiments, the particles may have a particle size ranging from about 2 to about 14 microns. In some embodiments, the particles may have a particle size ranging from about 4 to about 10 microns. In some embodiments, the particles may have a particle size ranging from about 6 to about 8 microns.

Suitable anti-scanning particles include fine color effect pigments that defract and/or shift light. In one embodiment, hollow spherical particles having the above described particle sizes may be used. Nonlimiting example of the particles includes fine mica pigments available from Engelhard Corp. (Peeksill, N.Y.) or clear hollow spheres available from Prizmalite, (New York, N.Y.). In some embodiments, the particle may also function to shift the wavelength of light. Preferably, the particles are clear to serve as a covert security feature in the form.

In some embodiments, the particles may be about 0.5 to about 30 weight percent in the upper indicia receiving layer of the form. In some embodiments, the particles may be about 2 to about 20 weight percent in the upper layer of the form. In some embodiments, the particles may be about 1 to about 3 weight percent in the upper layer of the form. In some embodiments, the minimum amount of particles is about 2 weight percent of the upper layer of the upper surface of the transparent lamina construction.

Such particles may be mixed with the coating materials using standard high speed and high shear mechanical mixers. Such particles may be delivered to the solution or dispersion and deposited as a coating on the form.

### Working Example

A tamper evident form according to FIG. 1 was made. Such form incorporated a scrambling layer 15, a transparent lamina 10, a breakaway layer 20 disposed in diagonal lines covering approximately 50% of the upper surface of the transparent layer, a solvent reactive coating 25, and a heat reactive coating layer 30. Print information was received on upper surface 31 of the heat reactive coating layer. The form was printed using an IBM 4000.

Such form was tested by Pira International applying APACS Standard 72 which is set by APACS (London), a trade organization which sets standards for bill pay systems. The form passed Levels 1.1 (Optical), 1.1 (Physical: tampering), 2.1, 2.2, 2.3 (Optical), 2.1, 2.2 (Physical tampering), 2.3 (Simple tools & observation under special conditions), 2.1 (Chemical), 3.1, 3.2 (Optical), 3.1, 3.2, (Physical: image transfer), 3.1 (Chemical).

The various methods and techniques described above provide a number of ways to carry out the invention. Of course, it is to be understood that not necessarily all objectives or advantages described may be achieved in accordance with any particular embodiment described herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to preform methods in accordance with the principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

What is claimed is:

1. A tamper evident form comprising:
an upper layer being adapted to receive printed indicia;
a lower layer adapted to render the printed indicia of the upper layer unreadable;
an intermediate layer at least partially removably affixed to the upper surface of the lower layer, the intermediate layer being between the upper and the lower layers; and
a breakaway layer disposed on the upper surface of the intermediate layer and between the intermediate layer and the upper layer, the breakaway layer adapted to separate from the intermediate layer when a sufficient force is applied to the upper layer.

2. The tamper evident form of claim 1, wherein the separation of the lower layer from the intermediate layer renders the printed indicia readable.

3. The tamper evident form of claim 1, wherein the lower layer comprises a scrambling or opaque image.

4. The tamper evident form of claim 1, wherein the upper layer comprises a polymeric system capable of bonding with a paper or film substrate on an upper surface when exposed to a temperature of greater than 130° F. for at least 3 seconds at a pressure of greater than 15 psi.

5. The tamper evident form of claim 1, wherein the breakaway layer only partially covers the upper surface of the intermediate layer.

6. The tamper evident form of claim 1, wherein an upper surface of the breakaway layer has an adhesion to a layer contacting the upper surface greater than the adhesion of a lower surface of breakaway layer to the intermediate layer.

7. The tamper evident form of claim 1, wherein the sufficient force is greater than peel force of the breakaway layer and the intra-layer bonding between one or more layers positioned above the breakaway layer.

8. The tamper evident form of claim 7, wherein the printed indicia is rendered unreadable by the application of the sufficient force.

9. The tamper evident form of claim 1, wherein the upper surface of the intermediate layer is bonded to the upper layer either directly or through one or more other layers.

10. A tamper evident form comprising:
an upper layer being adapted to receive printed indicia, the upper layer comprising a polymeric system capable of bonding with a paper or film substrate on an upper surface when exposed to a temperature of greater than 130° F. for at least about 3 seconds at temperatures of greater than 15 psi;
a lower layer adapted to render the printed indicia of the first transparent layer unreadable; and
an intermediate layer at least partially removably contacting the upper surface of the lower layer, the intermediate layer being between the upper and the lower layers.

11. The tamper evident form of claim 10, wherein separation of the lower layer from the intermediate layer renders the printed indicia readable.

12. The tamper evident form of claim 10, wherein the upper layer and intermediate layer are substantially transparent.

13. The tamper evident form of claim 10, wherein the lower layer comprises a scrambling or opaque image.

14. The tamper evident form of claim 1, further comprising a solvent reactive layer adapted to change color when exposed to a solvent.

15. The tamper evident form of claim 13, wherein the solvent reactive layer is the upper layer.

16. The tamper evident form of claim 14, wherein the solvent reactive layer is positioned adjacent to the upper layer.

17. The tamper evident form of claim 14, wherein the solvent reactive layer comprises a first portion and a second portion, the first portion being separated from the printed indicia by a first distance, the second portion being separated from the printed indicia by a second distance, the first distance being greater than the second distance.

18. The tamper evident form of claim 1, wherein the lower layer is bound to a substrate.

19. The tamper evident form of claim 18, wherein the substrate comprises a portion bound to the lower layer, the portion being removable from the substrate.

20. The tamper evident form of claim 17, wherein the substrate comprises other printed indicia which is readable.

21. The tamper evident forms of claim 17, wherein the substrate is unaltered if the breakaway layer is separated.

22. A method of rendering printed information tamper-evident, the method comprising the steps of:
providing the tamper evident form of claim 1; and
printing indicia on the upper surface of the form.

23. A method of producing a tamper evident form, the method comprising:
bonding a first transparent lamina having an exposed upper surface with a lower non-transparent lamina bearing a scrambling pattern which is visible from above the transparent lamina,
applying a breakaway layer to the exposed upper surface of the first transparent lamina;
applying a printable coating capable of receiving printed indicia to a top surface of the form, wherein the breakaway layer has a greater adhesion to the printable coating than to the first transparent lamina; and wherein the printed indicia cannot be read while the scrambling pattern is under the printed indicia.

24. A method of reading scrambled printed indicia on a tamper evident form, the method comprising:
receiving a material, the material having at least a portion having a construction of a first layer, a second layer, a third layer, and a breakaway layer, the first layer comprising a scrambling pattern, the second layer bonded directly or indirectly to the first layer, the second layer comprising a transparent lamina, the third layer comprising printed indicia, wherein the breakaway layer is positioned between the second layer and the third layer; and
removing the first layer from the second layer.

25. A method of printing indicia on a tamper evident fomm, the method comprising:
receiving a material, the material having at least a portion having a construction of a first layer, a second layer, a third layer, and a breakaway layer, the first layer comprising a scrambling pattern, the second layer bonded directly or indirectly to the first layer, the second layer comprising a transparent lamina, the third layer capable of receiving printed indicia, wherein the breakaway layer is positioned between the second layer and the third layer; and
printing indicia on the third layer.

26. The method of claim 24, wherein the third layer comprises a polymeric material capable of bonding to a transfer on the upper surface of the third layer when exposed to a temperature of greater than 130° F. for at least about 3 seconds at temperatures of greater than 15 psi.

27. The method of claim 24, wherein the material further comprises a fourth layer disposed between the third layer and the breakaway layer.

28. The method of claim 27, wherein the fourth layer is configured to change color if exposed to a solvent.

29. The method of claim 24, wherein the third layer is the upper surface of the material.

30. The method of claim 24, wherein the printed indicia is on the upper surface of the third layer.

31. The method of claim 24, wherein the printed indicia is unreadable.

32. The method of claim 24, wherein the first layer is separable from the second layer.

33. The method of claim 24, wherein the first layer is separable from the material.

34. The method of claim 24, wherein the first layer is peelable from the material.

35. The method of claim 24, wherein the scrambling pattern is removable from the first layer.

36. A tamper evident form comprising:
a scrambling layer having a first upper surface and a first lower surface, the first lower surface bonded to a substrate;
a transparent layer having a second upper surface and a second lower surface, the second lower surface bonded to the first upper surface of the scrambling layer;
a breakaway layer having a third upper surface and a third lower surface, the third lower surface partially covering the second upper surface of the transparent layer; and
a printable layer having a fourth upper surface and a further lower surface, the printable layer positioned above the first transparent layer and the breakaway layer.

37. The tamper evident form of claim 36, wherein the breakaway layer is noncontinuous.

38. The tamper evident form of claim 36, wherein the printable layer is adhered directly to both the breakaway layer and the transparent layer.

39. The tamper evident form of claim 36, wherein the printable layer is adhered to a first layer, the first layer being bonded to and in contact with the breakaway layer and the transparent layer.

40. The tamper evident form of claim 36, wherein the scrambling layer comprises a scrambling pattern or an opaque surface.

41. The tamper evident form of claim 36, wherein the scrambling layer is configured to render indicia on the printable layer unreadable.

42. The tamper evident form of claim 36, wherein the printable layer is configured to bond to a transfer medium when exposed to a temperature of greater than 130° F. for at least about 3 seconds at temperatures of greater than 15 psi.

43. A tamper evident form comprising:
a scrambling layer having a first upper surface and a first lower surface, the first lower surface bonded to a substrate;
a transparent layer having a second upper surface and a second lower surface, the second lower surface bonded to the first upper surface of the scrambling layer;
a printable layer having a third upper surface and a third lower surface, the printable layer positioned above the first transparent layer, the printable layer being a heat reactive layer or a solvent reactive layer.

44. The tamper evident form of claim 43, wherein the scrambling layer comprises a scrambling pattern or an opaque surface.

45. The tamper evident form of claims 43, wherein the scrambling layer is configured to render indicia on the printable layer unreadable.

46. A method of printing indicia on a tamper evident form, the method comprising:
printing indicia on an upper surface of the form of claim 1.

47. A method of reading scrambled printed indicia on a tamper evident form, the method comprising removing the scrambling layer or the scrambling pattern from the form of claim 1.

48. The tamper evident form of claim 1, wherein the scrambling layer or pattern may be optically altered or negated to render the printed indicia readable.
